(19) United States
(12) Patent Application Publication
(10) Pub. No.: US 2026/0368369 A1
(43) Pub. Date: Nov. 19, 2026

(54) CRYPTOGRAPHIC IMPLEMENTATIONS WITH PARTITIONING AND COMBINING LINEAR OPTIMIZATIONS

(71) Applicant: QUALCOMM Incorporated, San Diego, CA (US)

(72) Inventors: Nicolas Thaddee COURTOIS, Mougins (FR); Alexandre BONNARD DE FONVILLARS, Juan les Pins (FR); Marco MACCHETTI, Lausanne (CH); Matthew MCGREGOR, Huntington Beach, CA (US); Anthony MAURE, Grasse (FR)

(21) Appl. No.: 19/212,609

(22) Filed: May 19, 2025

(51) Int. Cl. G06F 21/72; G06F 30/337

(52) U.S. Cl. CPC G06F 21/72; G06F 30/337

(57) ABSTRACT

Systems and techniques are provided for circuit design. For instance, a process can include decomposing a cryptographic operation into a set of affine functions, selecting two or more affine functions, from the set of affine functions, merging the selected two or more affine functions into a set of matrices, and combining the merged affine functions to generate an output value.

### FIELD

Aspects of the present disclosure generally relate to device security. For example, aspects of the present disclosure relate to cryptographic implementations with input space partitioning and using multiple linear approximations.

### INTRODUCTION

Computing devices typically store sensitive data owned by users or enterprises, with firmware or operating system software on the computing devices owned by a computing device or secure module manufacturer. To help secure computing devices, cryptographic keys and cryptographic operations may be used to encrypt and/or decrypt data for use by the computing device. To encrypt and/or decrypt data, implementations of cryptographic algorithms may use substitution boxes (S-boxes). These S-boxes may perform substitutions which may obscure relationships between the cryptographic key (e.g., “key”) and ciphertext, or plain text of the ciphered data. Mathematically, an S-box should be nonlinear. In some cases, implementing an S-box in circuitry may be relatively expensive in terms of silicon area used and delays incurred by such circuitry. Techniques to reduce the area, latency, and/or power consumption of implementing S-boxes in circuitry may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for device security. In some aspects, an electronic device is provided. The electronic device includes a memory system comprising instructions; and a processor system coupled the memory system. The processor system is configured to: decompose a cryptographic operation into a set of affine functions, select two or more affine functions, from the set of affine functions, merge the selected two or more affine functions into a set of matrices, and combine the merged affine functions to generate an output value.

In some aspects, a method for circuit design is provided. The method includes: decomposing a cryptographic operation into a set of affine functions, selecting two or more affine functions, from the set of affine functions, merging the selected two or more affine functions into a set of matrices, and combining the merged affine functions to generate an output value.

In some aspects, a non-transitory computer-readable medium having stored thereon instructions is provided. The instructions, when executed by at least one processor, cause the at least one processor to: decompose a cryptographic operation into a set of affine functions, select two or more affine functions, from the set of affine functions, merge the selected two or more affine functions into a set of matrices, and combine the merged affine functions to generate an output value.

In some aspects, an apparatus for circuit design is provided. The apparatus includes: means for decomposing a cryptographic operation into a set of affine functions, means for selecting two or more affine functions, from the set of affine functions, means for merging the selected two or more affine functions into a set of matrices, and means for combining the merged affine functions to generate an output value.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations (e.g., processors, such as CPU, GPU, DSP, NPU, FPGA, etc.), memory or storage component(s), electronic blocks which ensure I/O connectivity and multimedia capabilities, and hardware modules associated with sensors or processing data from sensors, Image Signal Processors (ISPs), embedded discrete secure hardware modules, etc. or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example implementation of a system-on-a-chip (SoC), in accordance with some examples;

FIG. 2 is block diagram illustrating a decentralized multi-random number generator, in accordance with aspects of the present disclosure;

FIG. 3A illustrates a 2ⁿ: 1 multiplexer array, in accordance with aspects of the present disclosure;

FIG. 3B illustrates a subset sum circuit, in accordance with aspects of the present disclosure;

FIG. 3C illustrates a type of n: 1 multiplexer, in accordance with aspects of the present disclosure;

FIG. 4 is a block diagram illustrating expanded inputs for a cryptographic function, in accordance with aspects of the present disclosure;

FIG. 5 is a block diagram illustrating expanded inputs and periodic architecture with outputs of one type of cryptographic function, to a different implementation b of the same type function, and vice-versa in a loop, in accordance with aspects of the present disclosure;

FIG. 6 is a flow diagram illustrating an example of a process for generating and implementing a circuit, in accordance with aspects of the present disclosure; and

FIG. 7 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Cryptographic algorithm using cryptographic keys may use substitution boxes (S-boxes) to perform substitutions which may be used to obscure relationships between the cryptographic key (e.g., “key”) and ciphertext, or plain text of the ciphered data. There are typically many layers of substitutions which perform complex transformations on an internal state. Another type of cryptographic algorithm may be composed of several layers of algebraic transformations involving and mixing several inputs locally such as small invertible matrices, number theoretic transform (NTT) butterflies, and other operations in finite fields, polynomial rings or algebraic curve rational points. Mathematically, each S-box or local transformation should be nonlinear, but upon analysis all S-boxes can be approximated and have multiple partial linearization results (PLR) which can be discovered and studied separately with focus on those of maximum strength (e.g., those solutions which work for a set of input points as large as possible). These PLR may be defined as portions or subsets V of the S-box input space where the overall transformation can be simplified as a function and the transformations operate linearly to map all of the values in V permitted. These partial implementations for each set V may be fully linear and may therefore be implemented using exclusive OR (XOR) and/or NOT (inverter) gates in characteristic 2, or otherwise with other simple local algebraic group operations. In the case of neural networks and/or processor (e.g., graphics processing unit (GPU), neural processing unit (NPU), etc.) operations, these PLR operations may be linear functions over real numbers, with S-boxes PLRs as binary matrices with 0/1 entries, or other matrices over a suitable finite field or ring. Such operations can be represented and studied in terms of matrices for the linear part and with additional constant translations. In some cases, several PLRs may be leveraged to allow cryptographic algorithms to be implemented in circuitry efficiently using partitioning and multiple linear approximations. This does not yet solve the problem of switching between these linear approximations and moreover it does not account for the cost and latency of switching. However, some efficiency gains may already emerge here: possibly several linear approximations can be computed at the same time and in parallel while computing concurrently a decision of which of these linear combinations may be used in the final result. A control input may be determined in parallel for a multiplexer or a linear combiner and several data inputs reusing internal variables for determining multiple linear approximations concurrently using a single linear circuit.

In some cases, partitioning and expanded linear optimizations may be applied to cryptographic operations, such as encrypting and/or decrypting data using a Dillon-Wolfe cryptographic function. The Dillon-Wolfe cryptographic function is understood to be extremely strong and is sometimes said to be almost perfect nonlinear or APN, Conventional implementations of Dillon-Wolfe tend take up approximately at least four times the silicon area as compared to conventional implementations of Advanced Encryption Standard (AES) functions. In some cases, techniques to implement similar cryptographic operations more efficiently may be useful. In some cases, a study of a new set of PLRs and a partition of the input space into disjoint sets of inputs points where each PLR is valid, may implementations to eliminate one of the PLRs and reduce the complexity of the circuit as fewer sets may cover the whole input space fully, and one or more PLRs can be discarded, thus reducing the complexity of both the selector and linear parallel portions.

Systems, apparatuses, processes (also referred to as methods), and computer-readable media (collectively referred to as “systems and techniques”) are described herein for a cryptographic implementation with partitioning and expanded linear optimizations. For example, a cryptographic circuit may be implemented by approximating a cryptographic or neural network operation by a set of linear or affine functions in several different ways. In mathematics there are many different types of affine or/and linear functions, depending on which basic group operation are used. As used herein, it may be assumed that the linear and affine functions are defined with respect to simple addition of vectors of elements in a binary finite field with values of 0/1, or more generally modulo some integer modulus, or in another finite group. An affine function or a linear function may then be represented by a matrix and a vector with entries being modulo p or in a small group, where the group might also be a finite field. While it may be possible to distinguish between linear affine functions, and linear functions are those represented by a matrix alone, with all-zero vector. In other cases, particularly in cryptography and presently, there may be no need to distinguish between linear and affine functions and affine function can also be considered linear. Linear or affine functions can also be represented by a vector of [multiple] polynomials of [multivariate] degree of at most 1. A cryptographic operation may be a task that uses a cryptographic key and algorithm to secure and/or authenticate data, such as encryption, decryption, or be a pure algebraic complex sequence of operations being a component of a larger cryptographic permutation, a digital signature scheme, or key encapsulation module. Decomposing the cryptographic operation may break down the cryptographic operation into a union of several affine approximations covering the whole input space. An affine function of the set of affine functions may be selected and merged with many other affine functions of the same type represented by several matrices and constants. At the end, one large linear transformation co-implements many initial linear transformations with substantial reuse of intermediate variables knowing that the fanout or the power consumption of this block may be limited as switching may not necessarily use the electric signals produced by some of the linear variants implemented, the output of the block may not depend on these values, and the block may discharge the capacitors only for a handful of bits decided by the final selection logic. In some cases, these approximation matrices may be a plurality (e.g., K) of fixed approximation matrices [plus K vectors]. In some cases, the plurality of fixed matrices may be merged into one single matrix. In some cases, the matrix may be stratified and certain linear or affine approximations may already be available in full at an earlier start or layer of XORs implementing an overall matrix. In this particular case, these bits can be connected to some slower portion of the multiplexer logic, such a larger OR or larger XOR of several parts to compensate the total delay and to avoid increasing a critical path length of a final overall combined circuit. The one or more matrices may be represented by a set of XOR gates or by a set of basic group operation boxes. In some cases, to co-implement several matrices, for example, 4 fresh XORs may be progressively and iteratively added at a time, where 4 may minimize a sum of Hamming Weights (HWs) of all output linear combinations which may be simultaneously computed later if these 4 extra bits were available. Then another 4 XORs may be added, and so forth. This may be repeated in several increments until all HWs become 1 with respect to a set of internal values already computed by the circuit. In some cases, the fanout of each XOR gate may be limited to, for example, 3 max by only considering 4-tuples of XORs which do not use previous linear combinations already used 3 times. In some cases, the merged affine function representing a simultaneous implementation of several matrices may be later combined or multiplexed to generate an output value for output which should come from a correct linear approximation. In some cases, several linear approximations or PLRs may be valid for certain inputs x, and control inputs may be freely programmed to select one of those valid implementation PLR choices. This additional freedom may, in some cases, lead to an overall cheaper implementation cost, while strictly respecting a fixed [overlapping] partition [of the input space] into several PLRs.

The merged affine function represents several partial implementations with matrices valid for some fraction of the full input space, which may be re-combined using a multiplexer array. The multiplexer array may be composed of different types of multiplexer arrays. In some cases, the merged affine function and matrices may be combined using an array of AND gates and an OR combiner. An AND gate may be a fundamental digital logic gate that generates a true output only when all of the inputs to the AND gate are true. Otherwise, the output is false. An OR combiner may include a set of OR logic gates which is a fundamental digital logic gate that outputs true if at least one input is true. Otherwise, the output is false. In some cases, a small number of gates in the multiplexer may deviate from standard practice and be XOR gates (output is true if and only if exactly one input is true). This may be useful to have if an XOR of two matrices from two PLRs is itself a useful PLR for a number of point fresh points x, as this may enhance the set of input spaces covered by the PLRs without increasing the size of the linear part. This works if both PLRs used have a low depth and/or all of their signals stabilize faster than in the worst case, which allows the extra latency of one XOR to be added without becoming a problematic output bit which lies on a critical path of the overall hardware implementation.

Various aspects of the present disclosure will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “mobile device” is used herein to refer to any one or all of cellular telephones, smartphones, Internet-of-things (IOT) devices, personal or mobile multi-media players, laptop computers, tablet computers, ultrabooks, palm-top computers, wireless electronic mail receivers, multimedia Internet enabled cellular telephones, wireless gaming controllers, smart cars, autonomous vehicles, and similar electronic devices which include a programmable processor, a memory and circuitry for sending and/or receiving wireless communication signals to/from wireless communication networks. While the various embodiments are particularly useful in mobile devices, such as smartphones and tablets, the embodiments are generally useful in any electronic device that includes secure boot circuitry for securing access to the electronic device.

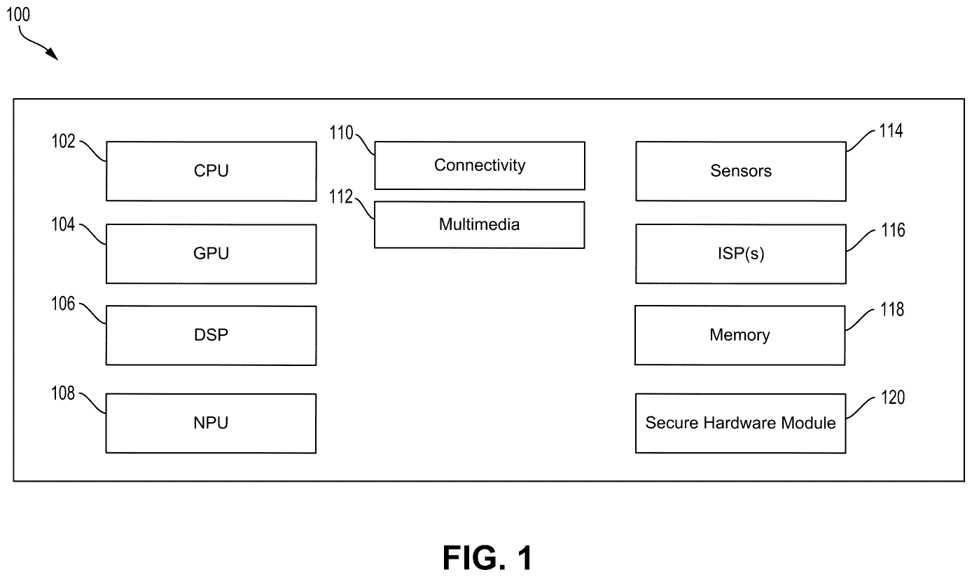

Various aspects of the techniques described herein will be discussed below with respect to the figures. FIG. 1. FIG. 1 illustrates an example implementation of a system-on-a-chip (SoC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

In some cases, the SoC 100 may include the CPU 102, which is based on an ARM instruction set. The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SoC 100 may also include a sensor processor 114, image signal processors (ISPs) 116, and/or secure hardware module 120.

The secure hardware module 120 may include fuses, replay protected memory block (RPMB), secure bits, secure flags, security enabled hardware, secure memory, or hardware, software, or firmware used to implement a secure portion of the operating system, a secure operating system (SOS), a trusted execution environment (TEE), trusted platform module (TPM), etc. The secure hardware module 120 may be used to process and/or store sensitive data in an environment that is segregated from the rich execution environment in which the operating system and/or applications may be executed. The secure hardware module 120 can be configured to execute trusted applications that provide end-to-end security for sensitive data by enforcing confidentiality, integrity, and protection of the sensitive data stored therein. The secure hardware module 120 can be used to store encryption keys, access tokens, and other sensitive data. The secure hardware module 120 may perform cryptographic operations, such as an encryption and/or decryption operations. In some cases, the secure hardware module 120 may serve as a RoT for the SoC 100. For example, the secure hardware module 120 may provide for the secure generation of cryptographic keys, limitations on the use of such cryptographic keys, and may contain one or more cryptographic keys or elements that may be used to authenticate the SoC 100. In some cases, the ROT may serve to anchor a chain of trust to validate other hardware and/or software. In some cases, the secure hardware module 120 may be implemented as a secure area of the CPU 102, as a part of the SoC 100, or any combination thereof.

In some cases, cryptographic algorithm using cryptographic keys may use substitution boxes (S-boxes) or basic polynomial arithmetic boxes, or basic NPU or LUT computation units, to perform substitutions which may be used to obscure relationships between the cryptographic key (e.g., “key”) or other sensitive input data and ciphertext, or plain text of the ciphered data or any exportable final data derived from protected sensitive data by several layers of complex calculations. Mathematically, an S-box or another algebraic transformation should be nonlinear, but upon analysis nonlinear components reveal relatively large partial linearization results (PLR). These PLR may be portions of the S-box which operate linearly to map values between the key and the ciphertext. In some cases, these PLR may be leveraged to allow cryptographic algorithms to be implemented in circuitry efficiently using partitioning and combined blocks leveraging several linear approximations computed in one single circuit. For example, an S-box may perform a function F and this function may be decomposed into smaller, simpler functions such as linear functions described by PLR properties. For example, the mapping of values from an input to an encryption function may be partitioned into sets of inputs x. PLR properties may be determined by linear algebra for various sets of inputs x, and which describes each of these PLR mappings by a matrix and a vector implemented using exclusive XOR circuits only or other group operations. A component G may be used to decide how to switch between the PLR properties. These PLR properties may be implemented jointly, and the vector space in which they live may be of small dimension in order to optimize and reduce computational complexity using an appropriate data encoding at the very input, which corresponds to an alternative possible redundant basis of the same affine input space. This data encoding may be made periodic in the sense that the first layer of linear transformations followed by non-linear transformations may produce a data encoding b incompatible with the data encoding a at the inputs of this layer, but compatible with the data encoding at the input of the next layer. The data encoding method may be a choice of an arbitrary generating matrix of a linear code which encoding and the linear code used in it may be different at each layer of the layered computational network.

Of note, the techniques for using partitioning and expanded linear optimizations discussed herein pertain to an architecture or development methodology for developing digital circuits and are not limited to cryptography, but may be applied to other fields, such as graphics processing, matrix operations, algebraic operations, neural networks, etc.

In some cases, partitioning and expanded linear optimizations may be applied to cryptographic operations, such as encrypting and/or decrypting data using a Dillon-Wolfe cryptographic function or another complex S-box which was constructed algebraically and which does not yet have a native efficient implementation. Of note, while discussed with respect to the Dillon-Wolfe function, it should be understood that the partitioning and expanded linear optimizations techniques discussed herein may be applicable to any cryptographic function of any size. The Dillon-Wolfe cryptographic function is understood to be extremely strong, but conventional implementations of Dillon-Wolfe tend take up approximately 4× the silicon area as compared to conventional implementations of Advanced Encryption Standard (AES) functions.

Initially, a cryptographic operation may be decomposed using a PLR decomposition for analysis and modeling. The PLR decomposition may be a result which may be used to model an operation, such as a block cipher with relatively few linear transformations. The PLR decomposition may, for example, reduce a non-linear S-box (S[x]) with k number of input bits to a smaller non-linear S-box which may be called G with only D bits, everything else being linear, when the output of the smaller S-box G is fixed. As a part of PLR decomposition, an SAT solver may be used to freely determine, for each input x to which PLR property ΣdAᵢ the input belongs. The SAT solver may be software which solves a Boolean satisfiability problem. Examples of SAT solvers may include CryptoMiniSat, Kissat, CaDiCaL, and the like. The problem is expected to produce a very large number of solutions and a stochastic SAT solver may pick one more or less at random, and repeat the whole discovery process many times. A manufacturer may diversify implementations of the circuit, by deploying a population of many different equivalent variants. The manufacturer can also over-cover the input space several times by PLRs, where each x belongs to several PLRs, which allows randomized switching between different valid implementation variants at runtime. This may be able to confuse AI reverse engineering and side channel attacks; leading to polymorphic non-deterministic implementations where several selector values are valid for each input x and any of them could be used at random. A SAT solver meta engine may include a machine learning module which may be trained on which options in SAT solver to use, or which limits or fine settings to use, or which SAT solver routines should be called to produce additional multiple solutions faster after an initial slower phase.

The PLR decomposition with D components may be performed by defining a new function G:

$${F}_{2}^{k} \to {F}_{2}^{D}$$

as a truth table with D·2^{k} variables G_{x,i} [symbol] G[X]ᵢ, for i=1, . . . , D for every x. Effectively, the function G is found by finding a truth table of G using a SAT solver or through mathematical facts about maximum size linear approximations possible in theory. The truth table of G may be a binary string of bits and the truth table may be defined as specifying the values of G in binary for each input x. The variables Gd may be binary control inputs (e.g., 0 or 1). Then a (not yet) optimized linear circuit may be written which computes for output, matrix Aᵢ times a vector x product, Aᵢ·x, for each of the D matrices which may have been found by a solver tool together with the full content of the G truth table. In some cases, all these circuits may be discovered using a SAT solver or another artificial intelligence solver software tool.

An array of D·k multipliers may be defined which selects which control inputs being the G_{x,i}, which F₂-linear combination of data outputs after an application of any one of the k matrices Aᵢ may be used.

The equation

$$S [ x ] = {\sum }_{i = 1}^{D} {G}_{x , i} \cdot {A}_{i} \cdot x + {\sum }_{i = 1}^{D} {G}_{x , i} \cdot {c}_{i} ∀ x ,$$

where x is an input value (e.g., value input to the S-box), may be solved by a SAT solver for the D·2^{k} bits being a truth table of G and for D·2^{k} being the matrices to be determined simultaneously in one single SAT solver run.

Solving for the above equation may result in a system of algebraic normal form (ANF) equations that may be converted into a conjunctive normal form (CNF). In some cases, this conversion may be performed using an ANF to CNF converter tool, examples of which may include a Courtois-Bard-Jefferson converter tool, Mate Soos' Bosphorus tool, Jovanovic's converter, and the like. Similarly, a conversion to a MiniZinc format may provide a faster ANF solving to find a valid assignment.

The converted CNF or MiniZinc equations may then be solved using the SAT solver to obtain the decomposition including a specification of G, such as a set of equations defining a truth table for G, and all the matrices Aᵢ. In some cases, G may be calibrated and defined by a set of low degree polynomial equations in order for the SAT solver to limit the delay and complexity to not exceed a latency of the linear parts running in parallel. In some cases, a smaller S-box G implementing an arbitrary function with a limited output size, and a square array of simple multipliers (e.g., AND gates) may also be generated in order to calibrate the maximum or average complexity of G by limiting their output size while imposing fewer PLR mappings which choice however might have a more limited impact on latency due to their co-implementation with a slowly increasing marginal extra cost curve.

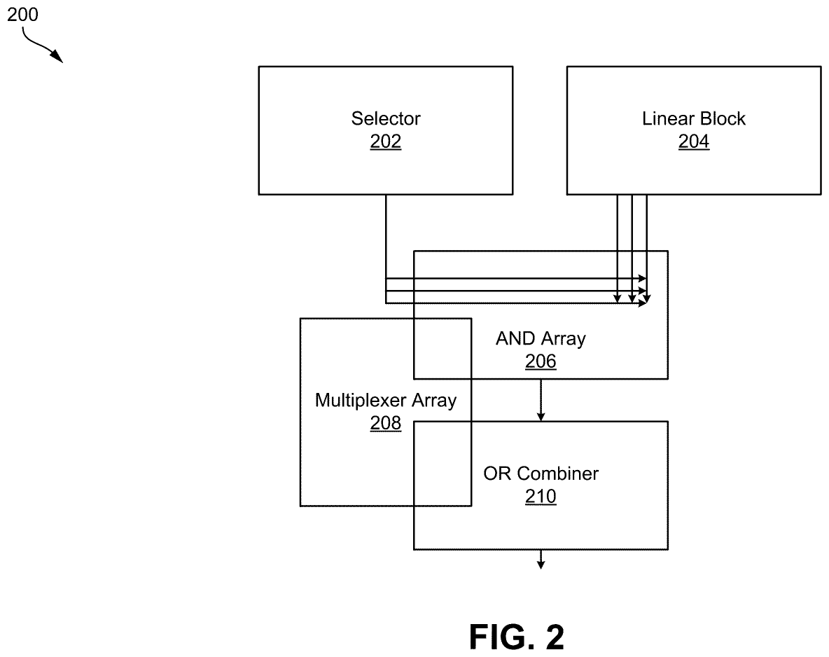

FIG. 2 is a diagram illustrating a circuit design for performing a cryptographic function 200, in accordance with aspects of the present disclosure. The cryptographic function 200 may be a Dillon-Wolfe function or a network of basic algebraic transformations. FIG. 2 includes a selector 202, a linear block 204, an AND array 206, a multiplexer array 208, and an OR combiner 210. The multiplexer portion may not depend strongly on the nature of operations being implemented except in rare cases where sums inside the 210 combiner. These sums can be XORs or other group operations, which occur in special cases where a sum of several PLRs are verified to approximate another fresh sets of inputs x of sufficiently large size to justify the cost of such complications. When these PLRs are computable with a slightly lower delay in order not to reduce the overall critical path which is a maximum over all possible inputs x.

The selector 202 may be a circuit which selects between several inputs to output a single output based on a control input defined by G. The truth table for G (e.g., as determined above) may be provided as input to the selector 202 as a number of short ANFs (e.g., as several low degree multivariate polynomials in the algebraic normal form (ANF) for cost calibration). For example, the truth table for G may be in the form of 12 short ANF or quadratic polynomials and each one of these polynomial expressions may be selected by the selector 202 (e.g., n:1 selector with only one bit at 1 at one time for one input x). In some cases, the selector 202 may be implemented with short sums of up to X terms of a low degree (limiting all products to multiply fewer variables together) which can then be added using XOR-4 or OR-8 blocks which summation method may be smaller, and yet work in all cases due to the limited number of non-zero values inside all possible vectors of these X terms. The selected ANF may also be passed to the AND array 206 as K selectors along with output of the linear block 204.

The linear block 204 may receive, as input, a set of D fixed matrices to consider possible variants to be used and implemented jointly in a single array of adders with some negations. In some cases, most of the results computed in 204 may not be used concurrently by the final multiplexer, which reduces the power consumption and fanout requirements in HW implementations. In some cases, the matrices of a set of fixed matrices may represent linear functions and smaller linear functions that are common intermediate values in implementing multiple matrices may be merged together. The linear functions may be further merged using any technique, for example to further re-optimize a circuit size of the linear block 204 with electronic design automation (EDA) tools or by exploring addition chains and small weight words in linear codes. For example, multiple matrix dot vectors Aᵢ·x may be merged into one single digital circuit due to re-use of the matrix dot vectors for the same fixed linear combinations of input variables, such as x₀+x₁+x₃+x₆ or because some outputs are XORs of just two (or very few) inputs previously used multiple times to produce the final bits of a matrix dot vector operation in the set of matrices being merged together. In some cases, the linear block 204 may be a set of linear gates that can be merged by reusing several times many affine linear combinations which may be computed as intermediate variables and which may repeat many time and may be computed once and re-used. This merged multiple linear block 204 may be run in parallel to the selector 202. In some cases, the linear block 204 may include a XOR tree with D layers of XOR gates. The linear block 204 may output K·n PLR output bits from any matrix implemented jointly. In some cases, linear gates are group operations and/or simple XORs. In some cases, negations are also added at inputs, at outputs, or/and their placement can be re-optimized by an EDA tool.

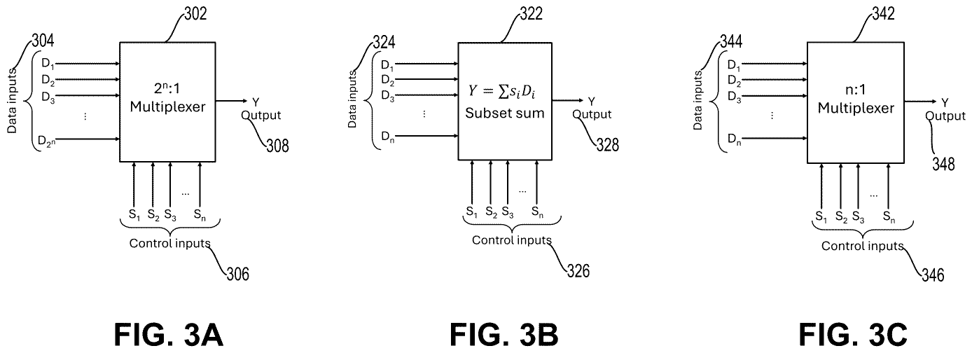

The AND array 206 may be a matrix or array of binary AND gates. The AND array 206 may perform an AND logical operation on the K selectors and K·n PLR output bits to merge the selected PLR bits and output only one PLR result at a time. The AND array 206 may be further processed by the OR combiner 210. The OR combiner 210 may perform a logical OR to generate mk outputs. The OR combiner 210 may include multiple layers of shorter OR gates. In some cases, the OR combiner 210 may be implemented using XOR gates in order to combine several PLRs additively to cover extra inputs x without adding more PLRs which could correspond to FIG. 3B or be a partial (local) use of additions for some output bits only where the XORs do not add extra latency and are not on a critical path, because the overall latency is dominated by larger/more layers of ORs used in other parts of the same circuit computing k output bits in parallel, only some of which would use any XORs if any.

In some cases, the AND array 206 may be stacked with the OR combiner 210 as a part of the multiplexer array 208. In some cases, a different type of multiplexer array 208 may be used in place of the AND array 206 and the OR combiner 210. The multiplexer array 208 may, based on a set of control inputs, select an output. The multiplexer array 208 may include a set of multiplexers which could be any of FIGS. 3A-3C and combinations of these, which receives, as input, partial linearization results which each may be correct solutions for the circuit in certain cases. The multiplexer array 208 may mix the partial linearization results and extract the correct solution from the partial linearization result inputs. The multiplexer array 208 may be implemented in a variety of configurations with MUX gates with any number of control inputs, or inverted MUX gates, and also arrays of AND later re-optimized away using yet cheaper NAND gates, typically followed by layers of OR gates, with some extra addition or negation gates when PLR optimization being implemented allows and/or uses any such extra sums.

FIGS. 3A, 3B, and 3C illustrate examples of basic multiplexer array configurations, in accordance with aspects of the present disclosure. It should be understood that the example multiplexer array configurations shown in FIGS. 3A-3C are not intended to be limiting and other multiplexer array configurations may be used. FIG. 3A illustrates a 2ⁿ: 1 multiplexer array 302, in accordance with aspects of the present disclosure. The 2ⁿ: 1 multiplexer array 302 may accept 2ⁿ inputs 304, where n is a number of control inputs 306 and generate one output 308. The control inputs 306 may be the bits of G_{x,i} discussed above. Based on the control inputs 306, a number of the 2ⁿ inputs 304 may be selected and merged into the output 308.

FIG. 3B illustrates a subset sum circuit 322, in accordance with aspects of the present disclosure. The subset sum circuit 322 may sum a number of a product of n inputs 324 and n control inputs 326 to generate an output 328. In some cases, the subset sum circuit 322 may sum a selected subset of linear combination of data inputs based on the control inputs 326. The control inputs 326 may be the bits of G_{x,i} discussed above.

FIG. 3C illustrates a type of n: 1 multiplexer array 342, in accordance with aspects of the present disclosure. This non-standard n:1 multiplexer array 342 may accept n inputs 344 and n control inputs 346 to generate one output 328. It is assumed that only one of these n selector bits Di are active at one time. This technique typically uses a large n and may to lead to an increased sized n of the output of the selector function. However, such a technique may reduce the latency of the function G and the power consumption of the multiplexer block. The control inputs 346 may be the bits of G_{x,i} discussed above. Based on the control inputs 346, one of the n inputs 344 may be selected and used for the output 328.

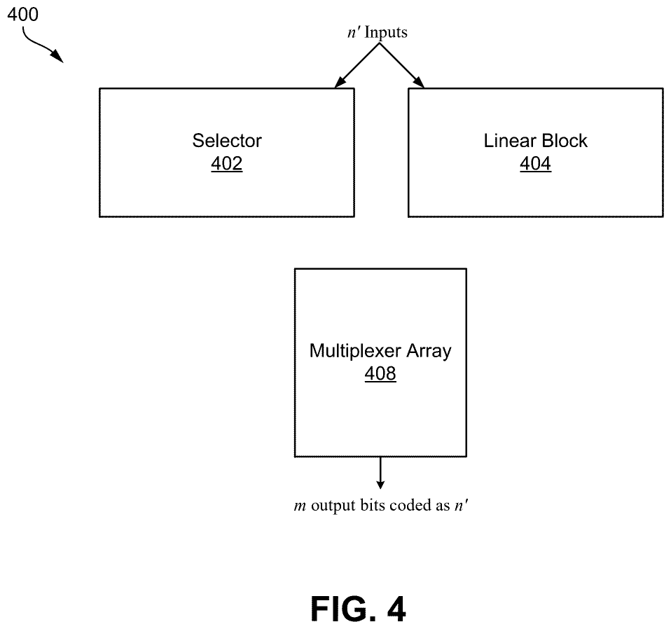

FIG. 4 is a block diagram illustrating expanded inputs for a cryptographic function 400, in accordance with aspects of the present disclosure. In some cases, the circuit for performing cryptographic functions 200 may be expanded. The input to truth table for G to a selector 402 and inputs to linear block 404 and set of fixed matrices may be expanded from n to n′bits or vector entries. For example, the n bit string in truth tables for G may be expanded to n′ bits to extend the state of the input data. In some cases, the n′ may be n+5 inputs as an example. By extending the state of the input data G and the inputs of matrices, the input data may be represented with linear redundancy, the computational cost of solving or implementing G and any of the linear parts may be reduced. The output of the selector 402 may remain the same while the output of the linear block 404 does not always need to remain the same. In some cases, the output of the multiplexer array may be some k bits which are re-coded as n′ bits, with the same n′ and the same redundant linear encoding as initially at the input side. In some cases, a different encoding at the output side may be used provided all the components which use these new data values are recoded likewise.

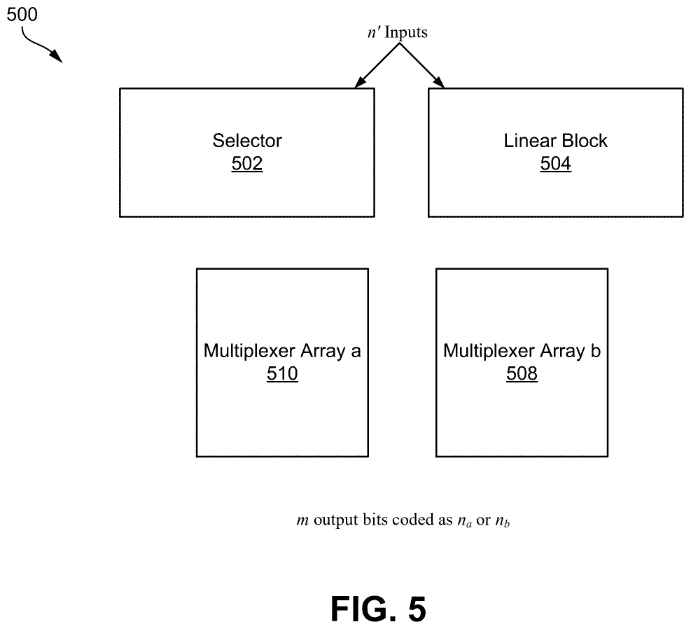

FIG. 5 is a block diagram illustrating expanded inputs and periodic outputs for a cryptographic function 500, in accordance with aspects of the present disclosure. In some cases, the cryptographic function 500 builds on two separate and distinct clones of cryptographic function 400 of FIG. 4 with different data encoding at the inputs and at the outputs, and uses nₐ or n_{b} expanded inputs respectively. In some cases, nₐ or n_{b} may be equal to n′ and connect to a block of FIG. 4. In some cases, the blocks form periodic sequences with a period M=2, 3 or higher where input encoding and output encodings vary in arbitrary ways and may form cycles. In some cases, the cycles allow pipelined implementations and re-use of block cipher after 2 or 3 rounds. As in FIG. 4, the input truth table for G to a selector 502 and linear block 504 and set of fixed matrices may be initially expanded from n to nₐ encoding. The output of the selector a 502 and linear block a 504 may be input to multiplexer array a 510 and multiplexer array a 510 may output m bits coded as n_{b} bits in a first execution. In a second execution the output of the selector b 502 and linear block b 504 may be input to multiplexer array b 510 and multiplexer array b 510 and may output m bits coded as nₐ bits, where nₐ bits≠n_{b} bits in both size encoding in terms of a basis of the linear space used. In some cases, multiplexer array a 510 may also have a different representation of data as compared to multiplexer array b 508 in order to avoid some self-similarity attacks at the price of making pipelined implementations more challenging.

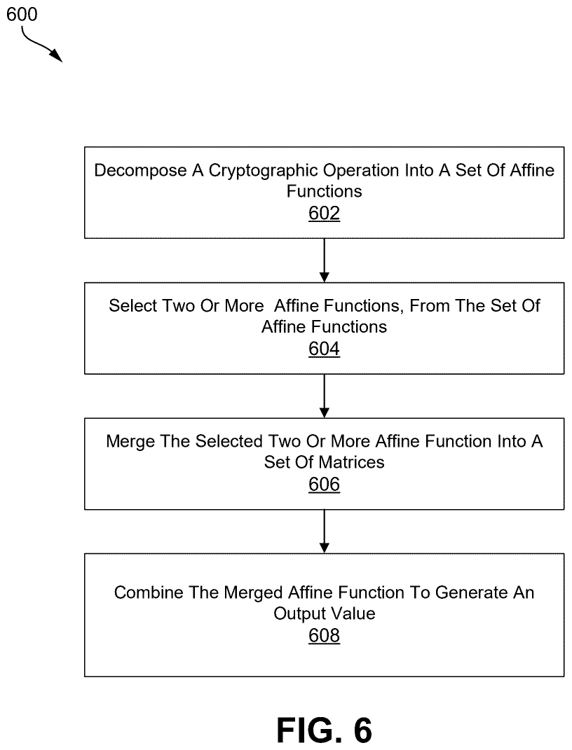

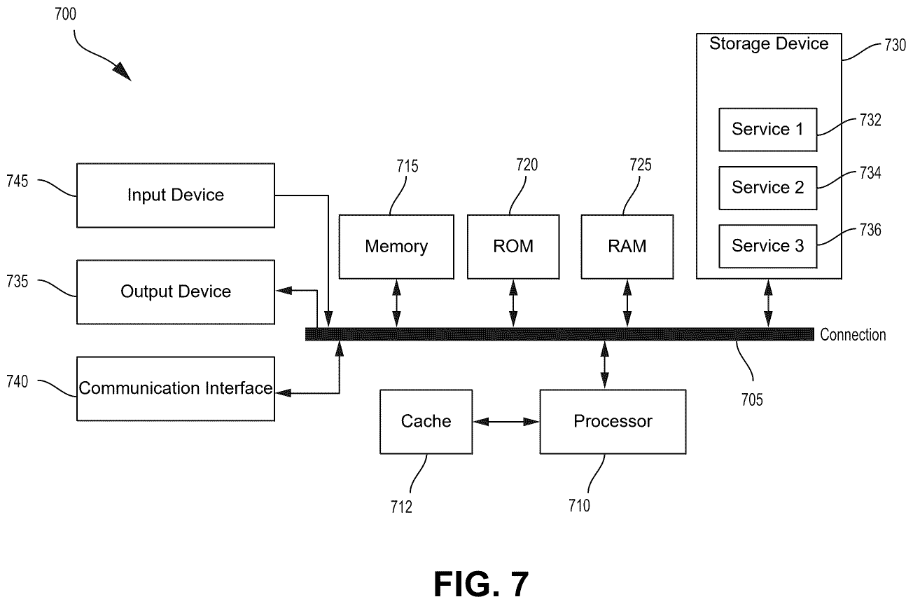

FIG. 6 is a flow diagram illustrating an example of a process 600 for generating a circuit, in accordance with aspects of the present disclosure. In some cases, the process 600 may be performed in advance rather than at runtime. The process 600 may be performed by a wireless device or by a component (e.g., SoC 100 of FIG. 1, processor 710 of FIG. 7, etc.) or system (e.g., a chipset) of the wireless device (e.g., computing system 700). The electronic device may be a wireless device, such as computing system 700, or a ME (e.g., a mobile equipment, or other device such as a mobile phone, tablet a network-connected wearable such as a watch, an extended reality device such as a virtual reality (VR) device or augmented reality (AR) device, a vehicle or component or system of a vehicle, or other type of ME) or other type of network or cloud node or chiplet or computing sub-system. In some examples, the process 600 may be performed by a ME. The operations of the process 600 may be implemented, in part, as software components that are executed and run on one or more processors (e.g., CPU 102 of FIG. 1, processor 710 of FIG. 7, or other processor(s)).

In some cases, the process 600 may decompose a cryptographic operation into a set of affine functions covering the whole input space by first finding one large size PLR linear approximation from a precomputed database, and merging it with another large PLR, until the full input space is covered at least once for every x. This process can be accelerated by precomputing a database of large size (and small overlap) pairs and triples of PLR properties which are sorted by their total strength. Their total strength may be measured by the sum of sizes of input spaces covered. A different metric of strength for tuples of PLR properties may also be used, for example a sum of sizes divided by their total joint linear implementation cost.

At block 602, the computing device (or component thereof) may decompose a cryptographic operation into a set of affine functions. For example, a cryptographic operation may be decomposed using a PLR decomposition for analysis and modeling.

At block 604, the computing device (or component thereof) may select two or more affine functions, from the set of affine functions. For example, a linear block, such as linear block 204 of FIG. 2, may receive, as input, a set of D fixed matrices to consider possible variants to be used.

At block 606, the computing device (or component thereof) may merge the selected two or more affine functions into a set of matrices. For example, smaller linear functions that are common intermediate values in implementing multiple matrices may be merged together. In some cases, the merged selected two or more affine functions are represented by one or more layers of exclusive OR (XOR) gates. In some examples, outputs of the merged affine function are used selectively by a multiplexer array. In some cases, the multiplexer array comprises at least one of a 2n: 1 multiplexer, a subset sum circuit, a n: 1 multiplexer, or a combination thereof. In some examples, the XOR logic gates are activated for a subset of inputs based on a sum of outputs of one or more matrices of the set of matrices. In some cases, the computing device (or component thereof) may expand outputs of the affine functions by a first number based on a matrix and multiplex the expanded outputs of the affine functions to generate a set of outputs. For example, the input truth table for G to a selector, such as selector 502 of FIG. 5, and linear block, such as linear block 504 of FIG. 5, and set of fixed matrices may be initially expanded from n to nₐ encoding. The output of the selector and linear block may be input to multiplexer array, such as multiplexer array 510 of FIG. 5. In some examples, the computing device (or component thereof) may expand and encode the set of outputs from a set of layers of a circuit to obtain a same data representation as in an input

At block 608, the computing device (or component thereof) may combine the merged affine functions to generate an output value. For example, an AND array, such as AND array 206 of FIG. 2, may perform an AND logical operation on the K selectors and Kon PLR output bits to merge the selected PLR bits and output only one PLR result at a time. In some cases, the merged affine function and one or more matrices are combined using an array of AND gates and an OR combiner. In some examples, the OR combiner comprises a set of OR logic gates. In some cases, the OR combiner comprises a set of XOR logic gates. In some examples, the merged affine functions are combined with an input dependent multiplexer choice between results obtained from several matrices.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 600 and/or other processes described herein may include a processor, microprocessor, micro-computer, or other component of a device that is configured to carry out the steps of the process 600 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data. In some cases, a small number of bits produced by one or more sensors, such as low-ranking bits in audio or video signals, or in some cryptographic S-boxes which do not depend on confidential information, may be used to increase entropy of one or more RNGs used in making a probabilistic randomized version with multiple PLRs, where for each input there could be more than one PLR, and the randomness is used to decide which output is used with a multiplier driven by random bits.

The components of the device or apparatus configured to carry out one or more operations of the process 600 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 600 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, or API calls to external hardware blocks, that perform particular functions and operate on particular data types. The order in which the operations are described is not intended to be construed as a limitation, and any number of the described operations can be combined in any order and/or in parallel to implement the processes.

Additionally, the processes described herein (e.g., the process 600 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a direct connection into processor 710, such as in a chipset architecture. Connection 705 may also be a virtual connection, networked connection, or logical connection.

In some aspects, computing system 700 is a distributed system in which the functions described in this disclosure may be distributed within a datacenter, multiple data centers, a peer to peer network, etc. In some aspects, one or more of the described system components represents many such components each performing some or all of the function for which the component is described. In some aspects, the components may be physical or virtual devices.

Example computing system 700 includes at least one processing unit (CPU or processor) 710 and connection 705 that communicatively couples various system components including system memory 725, such as read-only memory (ROM) 720 and random access memory (RAM) 725 to processor 710. Computing system 700 may include a cache 712 of high-speed memory connected directly with, in close proximity to, or integrated as part of processor 710. In some cases, an RNG outlet can also be connected in close proximity or integrated as part of any processor of the computing system 700.

Processor 710 may include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 730 may include software services, servers, services, etc., that when the code that defines such software is executed by the processor 710, it causes the system to perform a function. In some aspects, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 715, read-only memory (ROM) 720, random access memory (RAM) 725, storage device 730, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for circuit design, comprising: a memory system comprising instructions; and a processor system coupled the memory system, wherein the processor system is configured to: decompose a cryptographic operation into a set of affine functions; select two or more affine functions, from the set of affine functions; merge the selected two or more affine functions into a set of matrices; and combine the merged affine functions to generate an output value.
Aspect 2. The apparatus of Aspect 1, wherein the merged selected two or more affine functions are represented by one or more layers of exclusive OR (XOR) gates.
Aspect 3. The apparatus of any of Aspects 1-2, wherein outputs of the merged affine function are used selectively by a multiplexer array.
Aspect 4. The apparatus of Aspect 3, wherein the multiplexer array comprises at least one of a 2n: 1 multiplexer, a subset sum circuit, a n: 1 multiplexer, or a combination thereof.
Aspect 5. The apparatus of any of Aspects 1-4, wherein the merged affine function and one or more matrices are combined using an array of AND gates and an OR combiner.
Aspect 6. The apparatus of Aspect 5, wherein the OR combiner comprises a set of OR logic gates.
Aspect 7. The apparatus of any of Aspects 5-6, wherein the OR combiner comprises a set of XOR logic gates
Aspect 8. The apparatus of Aspect 7, wherein the XOR logic gates are activated for a subset of inputs based on a sum of outputs of one or more matrices of the set of matrices.
Aspect 9. The apparatus of any of Aspects 1-8, wherein the processor system is further configured to: expand outputs of the affine functions by a first number based on a matrix; and multiplex the expanded outputs of the affine functions to generate a set of outputs . . .
Aspect 10. The apparatus of Aspect 9, wherein the processor system is further configured to: expand and encode the set of outputs from a set of layers of a circuit to obtain a same data representation as in an input.
Aspect 11. The apparatus of any of Aspects 1-10, wherein the merged affine functions are combined with an input dependent multiplexer choice between results obtained from several matrices.
Aspect 12. A method for circuit design, comprising: decomposing a cryptographic operation into a set of affine functions; selecting two or more affine functions, from the set of affine functions; merging the selected two or more affine functions into a set of matrices; and combining the merged affine functions to generate an output value.
Aspect 13. The method of Aspect 12, wherein the merged selected two or more affine functions are represented by one or more layers of exclusive OR (XOR) gates.
Aspect 14. The method of any of Aspects 12-13, wherein outputs of the merged affine function are used selectively by a multiplexer array.
Aspect 15. The method of Aspect 14, wherein the multiplexer array comprises at least one of a 2n: 1 multiplexer, a subset sum circuit, a n: 1 multiplexer, or a combination thereof.
Aspect 16. The method of any of Aspects 12-15, wherein the merged affine function and one or more matrices are combined using an array of AND gates and an OR combiner.
Aspect 17. The method of Aspect 16, wherein the OR combiner comprises a set of OR logic gates.
Aspect 18. The method of any of Aspects 16-17, wherein the OR combiner comprises a set of XOR logic gates
Aspect 19. The method of Aspect 18, wherein the XOR logic gates are activated for a subset of inputs based on a sum of outputs of one or more matrices of the set of matrices.
Aspect 20. The method of any of Aspects 12-19, further comprising: expanding outputs of the affine functions by a first number based on a matrix; and multiplexing the expanded outputs of the affine functions to generate a set of outputs.
Aspect 21. A non-transitory computer-readable medium having stored thereon instructions that, when executed by at least one processor, cause the at least one processor to perform operations according to any of Aspects 12 to 20.
Aspect 22. An apparatus for circuit design including one or more means for performing operations according to any of Aspects 12 to 20.

What is claimed is:

1. An apparatus for circuit design, comprising:
a memory system comprising instructions; and
a processor system coupled the memory system, wherein the processor system is configured to:
decompose a cryptographic operation into a set of affine functions;
select two or more affine functions, from the set of affine functions;
merge the selected two or more affine functions into a set of matrices; and
combine the merged affine functions to generate an output value.

2. The apparatus of claim 1, wherein the merged selected two or more affine functions are represented by one or more layers of exclusive OR (XOR) gates.

3. The apparatus of claim 1, wherein outputs of the merged affine function are used selectively by a multiplexer array.

4. The apparatus of claim 3, wherein the multiplexer array comprises at least one of a 2ⁿ: 1 multiplexer, a subset sum circuit, a n: 1 multiplexer, or a combination thereof.

5. The apparatus of claim 1, wherein the merged affine function and one or more matrices are combined using an array of AND gates and an OR combiner.

6. The apparatus of claim 5, wherein the OR combiner comprises a set of OR logic gates.

7. The apparatus of claim 5, wherein the OR combiner comprises a set of XOR logic gates.

8. The apparatus of claim 7, wherein the XOR logic gates are activated for a subset of inputs based on a sum of outputs of one or more matrices of the set of matrices.

9. The apparatus of claim 1, wherein the processor system is further configured to:
expand outputs of the affine functions by a first number based on a matrix; and
multiplex the expanded outputs of the affine functions to generate a set of outputs.

10. The apparatus of claim 9, wherein the processor system is further configured to:
expand and encode the set of outputs from a set of layers of a circuit to obtain a same data representation as in an input.

11. The apparatus of claim 1, wherein the merged affine functions are combined with an input dependent multiplexer choice between results obtained from several matrices.

12. A method for circuit design, comprising:
decomposing a cryptographic operation into a set of affine functions;
selecting two or more affine functions, from the set of affine functions;
merging the selected two or more affine functions into a set of matrices; and
combining the merged affine functions to generate an output value.

13. The method of claim 12, wherein the merged selected two or more affine functions are represented by one or more layers of exclusive OR (XOR) gates.

14. The method of claim 12, wherein outputs of the merged affine function are used selectively by a multiplexer array.

15. The method of claim 14, wherein the multiplexer array comprises at least one of a 2ⁿ: 1 multiplexer, a subset sum circuit, a n: 1 multiplexer, or a combination thereof.

16. The method of claim 12, wherein the merged affine function and one or more matrices are combined using an array of AND gates and an OR combiner.

17. The method of claim 16, wherein the OR combiner comprises a set of OR logic gates.

18. The method of claim 16, wherein the OR combiner comprises a set of XOR logic gates.

19. The method of claim 18, wherein the XOR logic gates are activated for a subset of inputs based on a sum of outputs of one or more matrices of the set of matrices.

20. The method of claim 12, further comprising:
expanding outputs of the affine functions by a first number based on a matrix; and
multiplexing the expanded outputs of the affine functions to generate a set of outputs.
